(19) United States
(12) Patent Application Publication
(10) Pub. No.: US 2005/0129012 A1
(43) Pub. Date: Jun. 16, 2005

(54) SWITCH CAPABLE OF CONTROLLING DATA PACKET TRANSMISSION AND RELATED METHOD

(76) Inventors: Hau-Chun Ku, Taipei Hsien (TW); Weipin Chen, Taipei Hsien (TW); Ruth Lin, Taipei Hsien (TW); ChaoCheng Cheng, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,997

(22) Filed: Dec. 8, 2004

Related U.S. Application Data
(60) Provisional application No. 60/481,778, filed on Dec. 12, 2003.

(51) Int. Cl. H04L 12/56

(52) U.S. Cl. 370/389

(57) ABSTRACT

A switch capable of controlling data packets transmission includes at least one input port for receiving data packets, a plurality of output ports for outputting the data packets, and a decision logic for selecting one output port from the plurality of output ports depending on the transmission properties of the received data packets. In this way, the data packets transmission is improved by choosing one of these output ports which each connects to different network path with different transmission speed.

### CROSS REFERENCE TO RELATED APPLICATIONS

This application claims the benefit of U.S. Provisional Application No. 60/481,778, filed Dec. 12, 2003, and included herein by reference.

### BACKGROUND OF INVENTION

1. Field of the Invention

The present invention relates to a switch capable of controlling data packet transmission, more particularly, to a switch for choosing output port, which connects to different network path with different transmission speed according to transmission property of received data packet.

2. Description of the Prior Art

As applications of networks flourish, personal users and companies rely more and more on networks today, especially the use of Ethernet. The International Organization for Standardization (ISO) provides an open system interconnect mode (OSI) which can be accessed by the public. Standard network transmission uses a common mode in which there are seven levels of communication mode. The seven levels allow correspondence such as transmission, receiving and interruption, between two systems to be better managed. Since they are well known to those skilled in the art, the functions and usage of OSI will not be further mentioned here.

Before the transmission of data, the data is first divided into packets, and these packets are tagged with header information used for controlling the packet transmission. Please refer to FIG. 1, FIG. 1 illustrates a diagram of a data link layer of a packet 10. The data link layer belongs to level 2 of the OSI, which is a level that a switch normally acts on. The data link layer of the packet 10 comprises a preamble field, a destination field, a source field, a type field, data field, and a frame check sequence (FCS) field. Among these the preamble field provides information such as marking the beginning of the data packet, identifying synchronized message and decoding, etc. The destination field stores an end address of the data packet, and the source field stores a transmission of the address; both the destination field and the source field also store a medium access control (MAC) address. The type field stores a protocol (for example, IP protocol), the data field stores data content of the packet, and lastly the frame check sequence field allocates a check bit for a cyclic redundancy check (CRC).

Please refer to FIG. 2. FIG. 2 illustrates a diagram of local network 20 architecture. Local network 20 comprises a hub 24 or a switch 26, and one or more clients 28 coupled to the hub 24 or the switch 26. In the local network 20, which can range from tens to over hundreds of clients 28 connecting to the local network 20 at the same time, in order to ensure the speed of the local network 20, the hub 24 and the switch 26 increase intensities of signals and functions of network management. The hub 24 operates at a physical level of the OSI and is unable to analyze the MAC address field of the data link layer packet header. In other words, when the hub 24 receives a data packet, the data packet is transmitted to other ports. All the clients 28 that are connected to the same hub need to use up part of the bandwidth to process the received data packet, thus collisions of packets cannot be eliminated. If the number of clients in the network increases, efficiency will drop due to sharing of the same bandwidth.

A switch can solve these problems. As the switch operates at the level 2 data link layer of the OSI, when the data is divided into packets, the switch using point-to-point mode allocates the packet to the destination according to the MAC address (which is the destination field of FIG. 1). The switch at the same time can have many parallel transmissions, in this way, a chance of collision is lowered and also the bandwidth is put to full use, and hence, the efficiency of the whole network is increased.

Other than the hub and the switch, there is another apparatus known as a router. The main function of the router is packet transmission, and the router first needs to read the header of the packet to complete the transmission according to a method of processing each of the data within the header. At the same time, the router is capable of selecting a suitable route for the packet. The router determines a best route through setting up a routing table, and a related address is created for the router to refer to in order to seek the best suitable route. There are two methods of doing so: routing information protocol (RIP) and open shortest path first (OSPF). The principle behind RIP is that a request packet is sent out to an adjacent router, the receiving router sends back a routing table, and thus the request packet router can calculate the number of nodes in reaching every destination and record the nearest route in its own routing table. The main difference between OSPF and RIP is that OSPF is not an exchange between two routers but a broadcast over the entire network. Another difference is that the router uses a distance matrix instead of nodes in connecting situations to update distance parameters, and then uses a dynamic programming algorithm to calculate the shortest route. The next node and the total calculation of the distance parameter are filled into the routing table. No matter which method used, each router will automatically detect the information and create a communicating routing table to display the network situation of each channel, whether congested or interrupted, to create the best route for the data packet for ensuring transmission flow.

Although the router is capable of seeking the shortest route, it only functions at the third network layer of the OSI. A normal IP protocol belongs to the network layer protocol, and only an IP address above the network layer serves a purpose, addresses below the network layer are verified by the MAC address. In processing the packets, the router does not verify transmission addresses directly through the MAC address like the switch does, but rather through an address resolution protocol (ARP) that changes the IP protocol into a protocol of the MAC address, in order to know where each layer under the network layer sends the data to, or by using reverse address resolution protocol (RARP) in reverting the ARP to seek the IP address from the MAC address. Thus in this way, cost and complexity of the router is high, and under commercial considerations the router cannot replace the switch or the hub.

Most data transmission in a network splits the data into many packets at the source and transmits these packets to the destination end where the packets are assembled again. There are different types of data transmission schemes. As for online movies or online broadcasting, user demand is for smooth sound and visual transmission, through processing the sound and video will effectively reduce errors caused by data packet transmission, hence the network transmission puts emphasis on smooth high-speed transmission. As for electronic mail or program file transmission, a completed transmission is required in order to open the mail or the file, if part of the packet is not received properly, the content will be corrupted, hence the network transmission puts emphasis on the accuracy of content transmission.

FIG. 3 illustrates a basic structure layout of an Ethernet 500 that comprises a plurality of switches. Each switch 300a-300d comprises a fixed logic 340a-340d and each comprises a plurality of connectors 3000 (that can either be an input port or an output port). Each connector 3000 couples to a client 200, 202 or other switches. When the Ethernet is established, the transmission speed between the switches is fixed (with a theoretical maximum), which uses a cable of highest speed 100 MPS (such as 100 Base TX or 100 Base T4) or a cable of highest speed 10 Mbps (such as 10 BASE T) or other cables. By using a store-and-forward mode, according to a standard setting of each switch, the completed packet is received and checked for completeness and accuracy before transmission. By using a cut-through mode, in receiving part of the packet, judging the destination of the packet, and receiving and sending the packet at the same time, an internal component like a queue buffer is used to process the data packet. In another words, when the Ethernet is established, from the switch 300a to the switch 300c or from the switch 300b to the switch 300d or via other transmission paths, the speed of transmission is fixed. The transmission speed is usually slowed down due to a large amount of packets in transmission. It is obvious that those skilled in the art will recognize that the switch only processes MAC addresses and not IP addresses, and the transmission path of one switch to another switch is also fixed. For high-speed transmission, if the transmission path between different switches passes through a slower network cable or a switch which uses the store-and-forward mode, this transmission cannot fulfill its requirement. Likewise, for high-accuracy transmission, if the transmission path between different switches passes through a slower network cable or a switch that uses the cut-through mode, this transmission cannot fulfill its requirement. Even though high-speed cable is becoming common nowadays, due to the different modes of the switches used, the problem of a slow or inaccurate transmission path still exists.

Furthermore, those skilled in the art will recognize that the router has a function that seeks the shortest route. However this function basically connects one network to another network, and the transmission between a plurality of ends (such as a plurality of clients) inside a network is not processed. Thus, a data packet usually needs to be resolved to the third layer and so the volume of calculation needed as well as the load to the hardware increase. Under commercial consideration the switch is not suitable in the above-mentioned situation.

### SUMMARY OF INVENTION

The claimed invention relates to a switch and a related method of selecting a received data packet to perform a transmission through an output port (and other network transmission paths) in a more efficient way according to a transmission property of the received data packet.

A switch capable of controlling data packet transmission is disclosed. The switch comprises at least one input port for receiving a data packet, a plurality of output ports for transmitting data packets, and one decision logic for selecting an output port for outputting the data packet according to transmission property of the data packet received by an input port.

A method capable of utilizing a switch comprises receiving a data packet, selecting an output port from a plurality of output ports for outputting the data packet according to a transmission property of the data packet, and outputting the data packet through a selected output port.

In the claimed invention, when a network is established, by way of a mode of connecting all output ports of a switch to other switch ends, or by way of a mode where a network technician connects all related switch ends together, the switch will be updated either regularly or irregularly. During the operation of the switch, according to whether the transmission property of the received data packet indicates high-speed transmission or high-accuracy transmission, the switch selects which output port to transmit the data packet. In general, if the requirement for a high-speed transmission is high, a transmission path with a switch of the cut-through mode will be connected; if the requirement for high-accuracy transmission is high, then a transmission path with a switch of the store-and-forward mode will be connected.

The claimed invention, through analyzing the content of a particular byte of the data packet, is able to change the output port of the data packet, and thus there is no need to change the header of the data packet like in a router, thereby simplifying operation and reducing cost.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a format of a data link layer of a packet according to the prior art.

FIG. 2 illustrates a diagram of a conventional local network architecture.

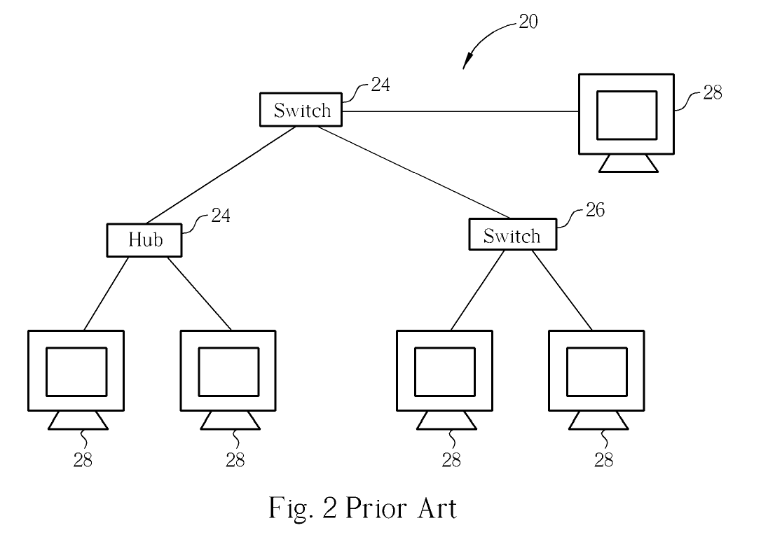

FIG. 3 illustrates a block diagram of a switch within an Ethernet, clients and other switches according to the prior art.

FIG. 4 illustrates a present invention functional block diagram of a switch within an Ethernet, clients and other switches.

FIG. 5 is a diagram of an IP packet format.

FIG. 6 is a diagram of a TCP packet format.

FIG. 7 is a diagram of a UDP packet format.

FIG. 8 is a flowchart of the present invention.

### DETAILED DESCRIPTION

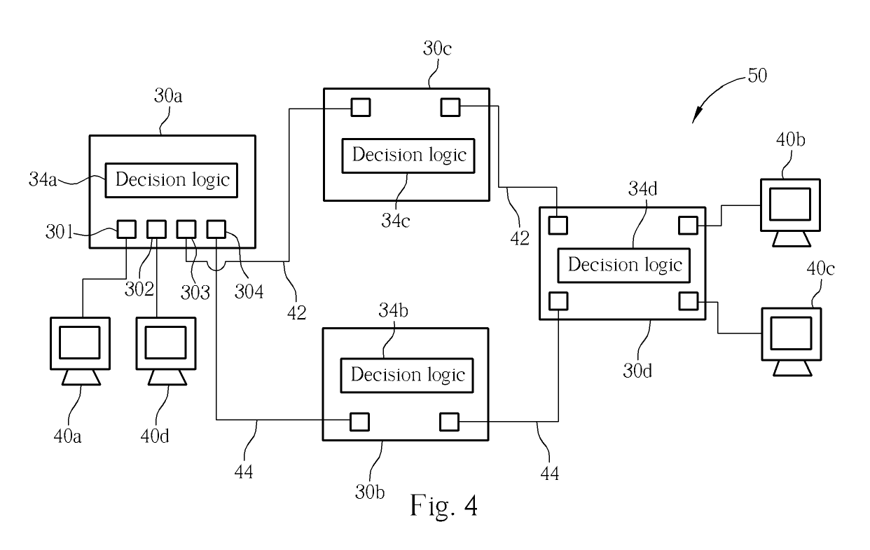

Please refer to FIG. 4. FIG. 4 illustrates a basic structure layout of an Ethernet 50 that comprises a plurality of switches. Each switch 30a-30d comprises a decision logic 34a-34d and each comprises a plurality of connectors 301-304, which can either be an input port or an output port. Also, the switch 30c uses a cut-through mode, and the switch 30b uses a store-and-forward mode. Other than that, the network cable between two switches can either be the same type of high-speed cable or a different type of high-speed cable, and the type of network cable does not affect the present invention.

When the Ethernet is established, in the transmission path from the switch 30a to the switch 30d, if transmission is via the switch 30c then the transmission has a faster processing rate, which means the transmission property indicates high-speed transmission of a data packet of a multi-media file. If the transmission is via the switch 30b then the transmission has a more accurate processing rate, which means the transmission property indicates high-accuracy transmission of a data packet of a program file.

One embodiment of the invention comprises a decision logic of the switch 30a for connecting to the output port of the switch 30c or to the output port of the switch 30b to transmit a data packet according to the transmission property of the data packet. The embodiment also extends to every switch in the plurality of switches comprising a decision logic. The decision logic 34a functions like a memory for recording every output port that couples to another switch (or client) to process the data packet and for analyzing the hardware/firmware used for reading the data packet. The data analyzed and the data recorded mentioned above is used to determine with which circuit of the output port to output data. The memory is a prior art device wherein information gathered when the network is established or connecting the switch and other surrounding ends, is written into the memory. The switch in the prior art for analyzing a MAC address in hardware/firmware of the data packet is modified. When two sources of data are to perform a calculation such as “if A is B and C is D”, and A (such as a data packet) points to a plurality of B (a plurality of output ports) is prior art as well, which also represents that the embodiment of the invention utilizes the decision logic to select an output port to output a data packet according to the transmission property of the data packet, and not according to the received data packet in the input port to determine which output port.

In a more detailed explanation, based on the content of the data packet the invention can determine whether a high-speed transmission requirement is needed, as in the case of a multimedia file, or a high-accuracy transmission requirement is needed, as in the case of a program file. In addition, the present invention can determine whether the data packet has a fast-transmission format or an accurate-transmission format through determining the format of the packet; or by reading the content of the data packet to determine the associated property of the data packet.

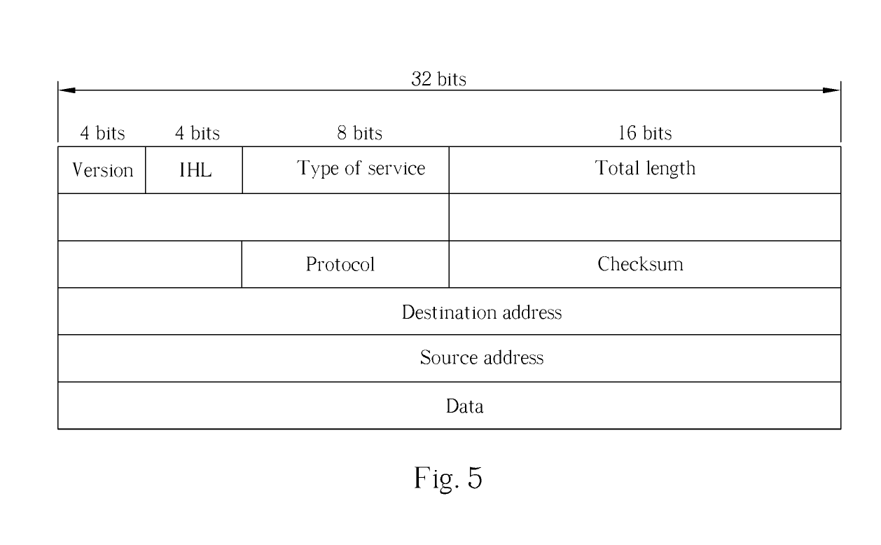

In order to explain the operation of the present invention, please refer to FIG. 5. FIG. 5 illustrates the format of an IP packet. A version field in the IP packet stores the version of the protocol in the data packet. A network header length (IHL) field sets the length of the IP header of the IP packet where the value is 5 to 15. In FIG. 5, the value of the IHL stored is 5. A total length field stores the full length of the IP packet which includes the length of the IP header and length of the data. A protocol field stores type of network protocol used. For example, if the value of the protocol field is 6, it represents TCP, and if the value of the protocol field is 17, it represents a UDP. A checksum field ensures the completeness of the IP header. A source address stores the address of the sending client and a destination address stores the address of the receiving client. The source address and the destination address are actually IP addresses. A data field stores data.

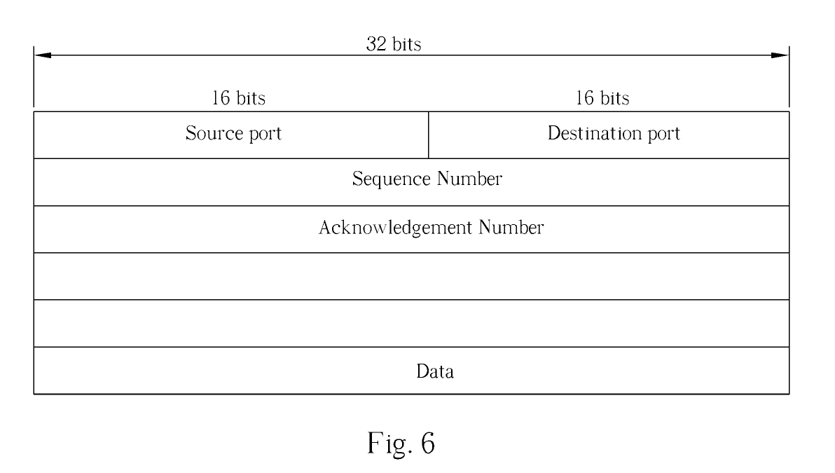

As each IP packet transmission has a different arrival time, the sequence of arriving packets does not represent the sent sequence, and this may cause errors in transmission. To ensure that a packet arrives correctly, in general, TCP is used to strengthen reliability of transmission. Therefore the data field of the IP packet stores a TCP packet. Please refer to FIG. 6. FIG. 6 illustrates the format of a TCP packet. A source port field can be used to define a source client route and a service address, which when combined with the IP address of the source client forms a send-out point. A destination port field can be used to define a destination client route and a service address, which when combined with the IP address of the destination client forms a send-out point. For example, a port number of 25 corresponds to an SMTP service, a port number of 21 corresponds to a file transfer protocol (FTP) service, and a port number of 23 corresponds to a TELNET service. A sequence number field stores a sequence number of first byte sent out by the source client. An acknowledgement number field stores data of when the source client notifies the destination client which sequence number is to be sent. Generally, TCP is used to ensure the reliability of data transmission, which also means by using the TCP transmission, the packet can arrive at the destination in sequence. The TCP packet will not be described further, since it is well known. However, further detailed description can be found in references RFC-793, RFC-1122, RFC-813, RFC-879, and RFC-896.

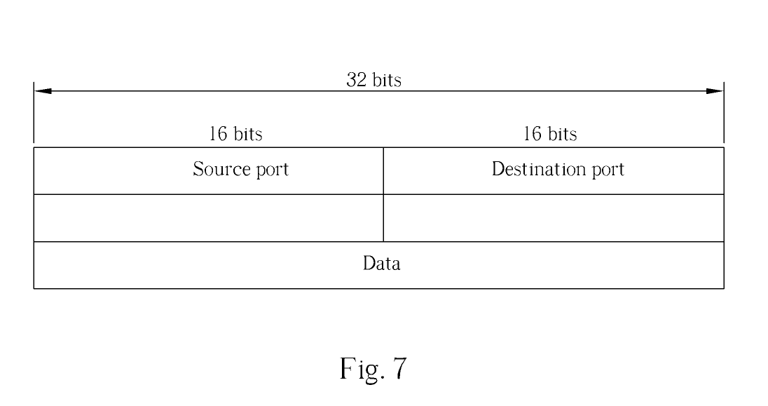

Please refer to FIG. 7. FIG. 7 illustrates the format of a UDP packet. A source port field can be used to define a source client route and a service address. A destination port field can be used to define a destination client route and a service address. UDP does not guarantee that a data packet sent out will arrive at the destination in sequence. In a local network, the UDP transmission reaches almost an arrival rate of 100%, and the rate of arrival can actually be faster than the rate of processing by the receiving end. As UDP uses a short packet and simple parameters, it is unlike TCP which needs additional fields to control the reliability of transmission; the load in the network is lighter in comparison to TCP. Therefore the UDP protocol is mostly used in multi-media file transmission. Further description of UDP is omitted since it is well known. However, detailed description can be found in reference RFC-768.

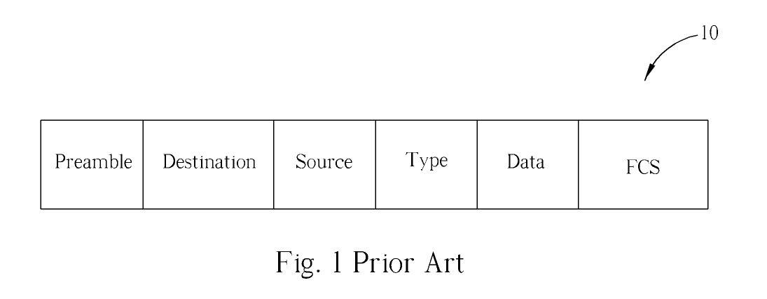

Please be aware that the IP packet of the network layer in FIG. 5 is stored in the data link layer packet 10 of FIG. 1. The TCP packet of FIG. 6 or the UDP packet of FIG. 7 is stored within the IP packet.

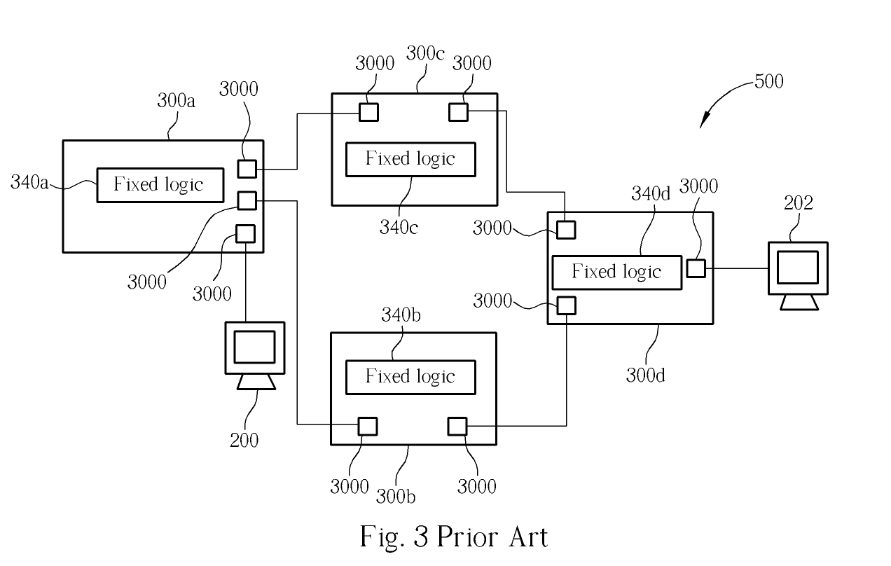

In FIG. 1, FIG. 3, FIG. 4, FIG. 5, FIG. 6 and FIG. 7, the particular address field (or the particular byte) of every data packet has a fixed definition. Therefore after the input port 301 of the switch 30a receives the data packet of the client 40a, the decision logic 34a is able to move the header of the data link layer. Under the circumstance where the IP header of the network layer is not moved by the present invention, the data of the particular field of the IP header is being read. Please be aware that the switch 30a only applies to the data link layer, therefore the decision logic 34a does not need to analyze the IP header of the network layer and the content of the TCP/UDP header. Rather, it only needs to take down the header of data link layer for reading the number in the version field from a 1st bit to a 4th bit to determine the version of the receiving IP packet used, from a 5th bit to an 8th bit to determine the length of the IP packet used, and from a 73rd bit to an 80th bit to determine type of protocol used for transmission, and so forth. The same method can be used to determine the source address and the destination address afterwards. Eventually, the header of the TCP/UDP packet comes after the IP header. Referring to FIG. 5, the value of the IHL is 5, and therefore the number in the version field from a 161st bit to a 176th bit belongs to the TCP/UDP packet of the source port and the number from a 177th bit to a 192nd bit belongs to the TCP/UDP packet of the destination port. The decision logic can also quickly interpret a port number that the packet uses. For example, if the port number is 25, the data packet will be used by the SMTP service, if the port number is 21, the data packet will be used by the FTP service. Lastly, the decision logic 34a is able to decide which mode to use for data packet transmission according to data such as transmission protocol.

For example, the client 40a uses UDP to transmit a multimedia file to another client 40b and the client 40d uses TCP to transmit an electronic mail to another client 40c. After the switch 30a receives from the connector 301 a data packet of the client 40a, the decision logic 34a can determine that the packet is to be transmitted to the client 40b through the MAC address field. However, there are two transmission paths to the client 40b, one is from the output port 303 to the switch 30c, and via the switch 30d to reach the client 40b. The other path is from the output port 304 to the switch 30b and via the switch 30d to reach the client 40b. The decision logic 34a can determine whether the data packet uses UDP by a number 17 in the version field from the 73rd bit to 80th bit. The decision logic also couples to the switch 30c to transmit data packets through the output port 303 that uses the cut-through mode. Similarly, the decision logic 34c in determining the data packet's destination MAC address field uses the UDP protocol to transmit the packet to the switch 30d. Lastly, the switch 30d transmits the packet to the client 40d according to the MAC address field of the packet. Relatively, after the switch 30a receives from the connector 302 a data packet of the client 40d, the decision logic 34a can determine how the packet is to be transmitted to the client 40c through the MAC address field and whether the data packet uses TCP indicated by a number 6 in the version field from the 73rd bit to 80th bit. The decision logic also couples to the switch 30b to transmit data packets through the output port 304 which uses the store-and-forward mode. Similarly, the decision logic 34d in determining the data packet's destination MAC address field uses the TCP protocol to transmit the packet to the switch 30d. Lastly, the switch 30d transmits the packet to the client 40c according to the MAC address field of the packet. The decision logic 34 determines priority of the data packet not only by the value of the protocol field, but it can also use the source address and the destination address of a TCP/UDP packet to determine the priority of the data packet. In conclusion, the switch 30a is able to determine the output port used to transport the data packet according to the transmission property of different data packets.

In FIG. 4, the switch 30b-30d can be replaced by a hub, a repeater, a bridge or other network apparatus. The only limitation is the following: the decision logic 34a determines the transmission protocol of the data packet for deciding the transmission priority of the data packet (for example the priority of UDP comes before TCP), thus the decision logic 34a analyzes the status of the connectors 303, 304 and connects the UDP packet and outputs through the selected switch which uses the cut-through mode, to be received by the client 40b.

Furthermore, the present invention has the following available variations:

(a) If the transmission property of the data packet has a tendency towards (i.e. indicates) a high-speed transmission (for example a multimedia file), the decision logic selects an output port connected to a network transmission path of the greatest number of switches that use the cut-through mode to transmit data packets.

(b) If the transmission property of the data packet has a tendency towards a high-speed transmission (for example a multimedia file), the decision logic chooses and connects to a network transmission path to an output port of a nearest switch that uses the cut-through mode to transmit data packets.

(c) If the decision logic receives a plurality of data packets having transmission properties indicating high-speed transmission and outputting the plurality of received data packets by alternately using at least one output port connecting the switches that use a cut-through mode.

(d) If the transmission property of the data packet has a tendency towards a high-accuracy transmission, the decision logic selects an output port connected to a network transmission path of the greatest number of switches that use the store-and-forward mode to transmit data packets.

(e) If the transmission property of the data packet has a tendency towards a high-accuracy transmission, the decision logic chooses and connects to a network transmission path to an output port of a nearest switch which uses the store-and-forward mode to transmit data packets.

(f) If the decision logic receives a plurality of data packets having transmission properties indicating high-accuracy transmission and outputting the plurality of received data packets by alternately using at least one output port connecting the switches that use a store-and-forward mode.

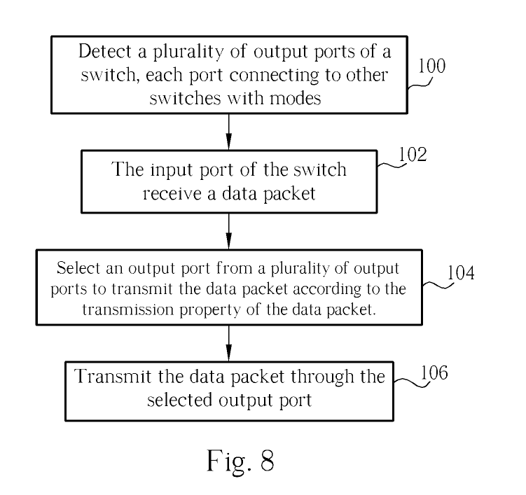

Please refer to FIG. 8, FIG. 8 illustrates a functional flowchart of a method according to the present invention. The steps are as follows:
Step 100: Detect a plurality of output ports of a switch, each port connecting to other switches with modes.
Step 102: The input port of the switch receives a data packet;
Step 104: Select an output port from a plurality of output ports to transmit the data packet according to the transmission property of the data packet;
Step 106: Transmit the data packet through the selected output port.

In comparison to the prior art, the switch of the present invention is capable of using the setting of a particular byte in a current network layer packet to analyze a data link layer of the switch. Other than splitting and analyzing the label of the data link layer by reading information of a fixed field of the label of the network layer packet, the switch is capable of differentiating the protocol used by the network layer packet and the port number used etc., to decide whether the network layer packet places emphasis on time efficiency or accuracy. As the switch connects to the connectors of other switches with different modes, if emphasis is placed on time efficiency, the network layer packet is transmitted through the output port which uses the cut-through mode. In contrast, if emphasis is placed on accuracy, the network layer packet is transmitted through the output port which uses the store-and-forward mode. Through such control mechanism, the switch of the local network of the present invention can provide the best network transmission management.

Those skilled in the art will readily observe that numerous modifications and alterations of the device and method may be made while retaining the teachings of the invention. Accordingly, the above disclosure should be construed as limited only by the metes and bounds of the appended claims.

1. A switch capable of controlling data packet transmission in a network comprising:
at least one input port for receiving a data packet;
a plurality of output ports for outputting received data packets, one output port of the plurality of output ports connected to network transmission paths; and
a decision logic for selecting an output port for outputting the received data packet according to a transmission property of the received data packet.

2. The switch of claim 1 wherein the data packet complies with an Internet protocol (IP).

3. The switch of claim 1 wherein when the transmission property of the received data packet indicates high-speed transmission, the decision logic selects an output port connected to a transmission path of the greatest number of switches that use a cut-through mode to transmit data packets.

4. The switch of claim 1 wherein when the transmission property of the received data packet indicates high-speed transmission, the decision logic selects an output port connected to a transmission path of a nearest switch that uses a cut-through mode to transmit data packets.

5. The switch of claim 1 wherein the decision logic receives a plurality of data packets having transmission properties indicating high-speed transmission and outputting the plurality of received data packets by alternately using at least one output port connecting the switches that use a cut-through mode.

6. The switch of claim 1 wherein when the transmission property of the received data packet indicates high-accuracy transmission, the decision logic selects an output port connected to a transmission path of the greatest number of switches that use a store-and-forward mode to transmit data packets.

7. The switch of claim 1 wherein when the transmission property of the received data packet indicates high-accuracy transmission, the decision logic selects an output port connected to a transmission path of a nearest switch that uses a store-and-forward mode to transmit data packets.

8. The switch of claim 1 wherein the decision logic receives a plurality of data packets having transmission properties indicating high-accuracy transmission and outputting the plurality of received data packets by alternately using at least one output port connecting the switches that use a store-and-forward mode.

9. The switch of claim 1 wherein the decision logic determines a transmission protocol used for the received data packet according to data in a protocol field of the received data packet to determine the transmission property.

10. The switch of claim 9 wherein the decision logic determines that:
if the received data packet indicates a user datagram protocol (UDP), the transmission property of the received data packet indicates high-speed transmission; and
if the received data packet indicates a transmission control protocol (TCP), the transmission property of the received data packet indicates high-accuracy transmission.

11. A method for a switch to control data packet transmission, wherein the switch comprises a plurality of output ports, comprising:
receiving a data packet;
selecting an output port for outputting the received data packet according to a transmission property of the received data packet; and
outputting the data packet through the selected output port.

12. The method of claim 11 wherein the data packet complies with an Internet protocol (IP).

13. The method of claim 11 wherein when the transmission property of the received data packet indicates high-speed transmission, the method selects an output port connected to a transmission path of the greatest number of switches that use a cut-through mode to transmit data packets.

14. The method of claim 11 wherein when the transmission property of the received data packet indicates high-speed transmission, the method selects an output port connected to a transmission path of a nearest switch that uses a cut-through mode to transmit data packets.

15. The method of claim 11 wherein the decision logic receives a plurality of data packets having transmission properties indicating high-speed transmission and outputting the plurality of received data packets by alternately using at least one output port connecting the switches that use a cut-through mode.

16. The method of claim 11 wherein when the transmission property of the received data packet indicates high-accuracy transmission, the method selects an output port connected to a transmission path of the greatest number of switches that use a store-and-forward mode to transmit data packets.

17. The method of claim 11 wherein when the transmission property of the data packet has a tendency towards a high-speed transmission, the method chooses and connects to a network transmission path to output port of nearest switch which uses a store-and-forward mode to transmit data packet.

18. The method of claim 11 wherein the decision logic receives a plurality of data packets having transmission properties indicating high-accuracy transmission and outputting the plurality of received data packets by alternately using at least one output port connecting the switches that use a store-and-forward mode.

19. The method of claim 11 comprises the method determining a transmission protocol used for the received data packet according to data in a protocol field of the received data packet to determine the transmission property.

20. The method of claim 11 wherein the method determines that:
if the received data packet indicates a user datagram protocol (UDP), the transmission property of the received data packet indicates high-speed transmission; and
if the received data packet indicates a transmission control protocol (TCP), the transmission property of the received data packet indicates high-accuracy transmission.
